(19) United States
(12) Patent Application Publication
(10) Pub. No.: US 2012/0251422 A1
(43) Pub. Date: Oct. 4, 2012

(54) Fe-SAPO-34 CATALYST AND METHODS OF MAKING AND USING THE SAME

(75) Inventors: Hong-Xin Li, Lansdale, PA (US); William E. Cormier, Harleysville, PA (US); Bjorn Moden, Glen Mills, PA (US)

(73) Assignee: PQ Corporation

(21) Appl. No.: 13/438,365

(22) Filed: Apr. 3, 2012

Related U.S. Application Data
(60) Provisional application No. 61/471,488, filed on Apr. 4, 2011.

(51) Int. Cl. B01J 29/85; B01D 53/56

(52) U.S. Cl. 423/239.1; 502/213

(57) ABSTRACT

There is disclosed a method of making, through direct synthesis, a catalyst comprising an Fe-SAPO-34 molecular sieve. There is also disclosed an Fe-SAPO-34 molecular sieve made according to the disclosed method herein, wherein the molecular sieve contains both framework iron and iron cations at ion-exchange sites. In addition, there is disclosed a method of using the Fe-SAPO-34 disclosed herein in a selective catalytic reduction reaction, typically in the presence of ammonia or urea, to reduce or remove nitric oxides from exhaust emissions.

This application claims the benefit of domestic priority to U.S. Provisional Patent Application No. 61/471,488, filed Apr. 4, 2011, which is herein incorporated by reference in its entirety.

The present disclosure is related to a method of making an iron-containing silicoaluminophosphate (“Fe-SAPO-34”) molecular sieve, by direct synthesis. The present disclosure is related to the Fe-SAPO-34 made through such methods, as well as methods of using the disclosed Fe-SAPO-34, in reducing contaminants in exhaust gases. Such methods include the selective catalytic reduction (“SCR”) of exhaust gases contaminated with nitrogen oxides (“NOₓ”).

Microporous crystalline materials and their uses as catalysts and molecular sieve adsorbents are known in the art. Microporous crystalline materials include crystalline aluminosilicate zeolites, metal organosilicates, and aluminophosphates, among others. One catalytic use of the materials is in the SCR of NOₓ with ammonia in the presence of oxygen and in the conversion process of different feed stocks, such as an oxygenate to olefin reaction system.

Medium to large pore zeolites containing metals, such as ZSM-5 and Beta, are also known in the art for SCR of NOₓ using reductants, such as ammonia.

A class of silicon-substituted aluminophosphates, which are both crystalline and microporous and exhibit properties characteristic of both aluminosilicate zeolites and aluminophosphates, are known in the art and disclosed in U.S. Pat. No. 4,440,871. Silicoaluminophosphates (SAPOs) are synthetic materials having a three-dimensional microporous aluminophosphate crystalline framework with silicon incorporated therein. The framework structure consists of PO₂⁺, AlO₂⁻, and SiO₂ tetrahedral units. The empirical chemical composition on an anhydrous basis is:

mR:(SiₓAl_{y}P_{z})O₂

wherein, R represents at least one organic templating agent present in the intracrystalline pore system; m represents the moles of R present per mole of (SiₓAl_{y}P_{z})O₂ and has a value from zero to 0.3; and x, y, and z represent the mole fractions of silicon, aluminum, and phosphorous, respectively, present as tetrahedral oxides.

U.S. Pat. No. 7,645,718 discloses a process for preparing Fe-exchanged SAPO-34 by a liquid phase ion-exchange method using an iron salt solution. Only small amounts of Fe were exchanged onto SAPO-34 using liquid phase ion exchange.

The process for preparing Fe-SAPO-34 by sublimation of FeCl₃ for use in SCR applications is disclosed in Kucherov et al., Catalysis Letters 56 (1998) 173-181. The dispersion of Fe is not as good as on the medium pore ZSM-5 using the sublimation method.

Patent Application, WO 2008/132452 discloses a method for preparing Fe-SAPO-34 from a slurry of SAPO-34 in a ferric nitrate solution for ammonia-SCR.

U.S. Patent Application Publication No. US 2009/0048095 A1 discloses a method for preparing high-silica Fe-chabazite and its use for SCR.

The art is silent on methods of making Fe-SAPO-34 that do not require some intermediate step, such as ion-exchange or impregnation. Thus, there is a need for an improved and simplified method of making Fe-SAPO-34 that does not require ion-exchange or impregnation, and that displays good activity and stability. To that end, the Inventors have discovered a method of directly synthesizing Fe-SAPO-34 that contains both framework iron and iron cations at ion-exchange sites.

### SUMMARY

Therefore, the present disclosure generally provides method of making Fe-SAPO-34, comprising: comprising mixing sources of an iron salt, alumina, silica, phosphate, at least one organic compound, and water to form a gel; heating the gel in an autoclave at a temperature ranging from 140 to 220° C. to form a crystalline Fe-SAPO-34 product; calcining the product; and contacting the product with acid or steam. The iron containing product at least 0.5%, such as from 1.0 to 5.0% of iron and contains both framework iron and iron cations at ion-exchange sites.

Other aspects of the present disclosure include methods of SCR of NOₓ in exhaust gas. One such method comprises contacting, in the presence of ammonia or urea, exhaust gas with the Fe-SAPO-34 described herein.

Aside from the subject matter discussed above, the present disclosure includes a number of other exemplary features such as those explained hereinafter. It is to be understood that both the foregoing description and the following description are exemplary only.

### BRIEF DESCRIPTION OF THE DRAWINGS

FIG. 1 compares SCR activity data of various Fe-SAPO-34 made by direct synthesis according to Examples 1 through 6.

FIG. 2 compares SCR activity data for steamed and unsteamed Fe-SAPO-34 prepared as described in Example 5. The steam conditions being 700° C., 16 h, 10% steam.

FIG. 3 shows the effect of acid-treatment and steaming on the SCR activity of Fe-SAPO-34. FIG. 3 also compares SCR activity at more severe conditions (900° C., 1 h, 10% steam vs. 700° C., 16 h, 10% steam).

FIG. 4 is a scanning electronic microscope image (“SEM”) of the Fe-SAPO-34 described in Example 1.

FIG. 5 is a SEM of the Fe-SAPO-34 described in Example 2.

FIG. 6 is a SEM of the Fe-SAPO-34 described in Example 3.

FIG. 7 is a SEM of the Fe-SAPO-34 described in Example 6.

FIG. 8 is an X-ray diffraction pattern (XRD) of the Fe-SAPO-34 described in Example 1.

FIG. 9 is a XRD of the Fe-SAPO-34 described in Example 2.

FIG. 10 is a XRD of the Fe-SAPO-34 described in Example 3.

FIG. 11 is a XRD of the Fe-SAPO-34 described in Example 6.

### DEFINITIONS

“Hydrothermally stable” means having the ability to retain a certain percentage of initial surface area and/or microporous volume after exposure to elevated temperature and/or humidity conditions (compared to room temperature) for a certain period of time. For example, in one embodiment, it is intended to mean retaining at least 80%, such as at least 85%, at least 90%, or even at least 95%, of its surface area and micropore volume after exposure to conditions simulating those present in an automobile exhaust, such as temperatures ranging up to 900° C. in the presence of up to 10 volume percent (vol %) water vapor for times ranging from up to 1 hour, or even up to 16 hours, such as for a time ranging from 1 to 16 hours.

“Initial Surface Area” means the surface area of the freshly made crystalline material before exposing it to any aging conditions.

“Initial Micropore Volume” means the micropore volume of the freshly made crystalline material before exposing it to any aging conditions.

“Direct synthesis” (or any version thereof) refers to a method that does not require an iron-doping process after the SAPO-34 has been formed, such as a subsequent ion-exchange or impregnation method.

“Selective Catalytic Reduction” or “SCR” refers to the reduction of NOₓ (typically with ammonia or urea) in the presence of oxygen to form nitrogen and H₂O.

“Exhaust gas” refers to any waste gas formed in an industrial process or operation and by internal combustion engines, such as from any form of motor vehicle.

### DETAILED DESCRIPTION

The Fe-SAPO-34 molecular sieve having both framework iron and iron cations at ion-exchange sites of the present disclosure exhibit good hydrothermal properties, as evidenced by the stability of the surface area and micropore volume after exposure to high temperatures and humidity.

There is disclosed a Fe-SAPO-34 molecular sieve wherein the iron comprises at least 0.5 weight percent of the total weight of the material, such as a range from 1.0-10.0, or even 1.0 to 5.0 weight percent of the total weight of the material.

In one embodiment, the Fe-SAPO-34 described herein has a crystal size greater than 0.3 microns, such as a size ranging from 0.5 to 10 microns.

There is also disclosed a method of selective catalytic reduction (SCR) of NOx in exhaust gas. In one embodiment, the method comprises contacting, typically in the presence of ammonia or urea, exhaust gas with a catalyst containing Fe-SAPO-34 as described herein. For example, the method comprises contacting exhaust gas with a Fe-SAPO-34 having a crystal size greater than 0.3 microns and 0.5 to 10 percent weight iron per weight of the total composition. The Fe-SAPO-34 typically exhibits a selective catalytic reduction of NOₓ with ammonia or urea of greater than 40% conversion at 250-300° C. In other embodiments, the Fe-SAPO-34 material described herein has an efficiency greater than 40%, such as greater than 60% conversion at 250-300° C.

The article described herein may be in the form of a channeled or honeycombed-shaped body; a packed bed; microspheres; or structural pieces. The packed bed comprises balls, pebbles, pellets, tablets, extrudates, other particles, or combinations thereof.

The structural pieces described herein may be in the form of plates or tubes.

In one embodiment, the channeled or honeycombed-shaped body or structural piece is formed by extruding a mixture comprising the Fe-SAPO-34 molecular sieve.

In another embodiment, the channeled or honeycombed-shaped body or structural piece is formed by coating or depositing a mixture comprising the Fe-SAPO-34 molecular sieve on a preformed substrate.

The Fe-SAPO-34 compositions of the present invention exhibit good hydrothermal and thermal properties as identified herein. For example, after being treated at temperatures up to 700° C. in the presence of up to 10 vol % water vapor for 16 hours, the inventive compositions maintain at least 60% of their initial surface area, such as at least 70%, or even at least 80%. Likewise, after the treatment, the inventive compositions maintain similar percentages of their initial micropore volume.

The Fe-SAPO-34 of the present invention is useful as exhaust catalysts, such as for reduction of NOₓ in automotive exhaust, in part because of their good thermal and hydrothermal stability. Under extreme conditions, automotive exhaust catalysts are exposed to heat up to and in excess of 700° C., such as 900° C. Therefore, some automotive exhaust catalysts are required to be stable at temperatures up to and in excess of 900° C.

The present invention is also directed to a method for reduction, typically prior to discharge, of exhaust gas. As mentioned, reference to “exhaust gas” refers to any waste gas formed in an industrial process or operation and by internal combustion engines, the composition of which varies. Non-limiting examples of the types of exhaust gases that may be treated with the disclosed materials include both automotive exhaust, as well as exhaust from stationary sources, such as power plants, stationary diesel engines, and coal-fired plants.

For example, the present invention is directed to a method for SCR of exhaust gases contaminated with NO_{R}. The nitrogen oxides of exhaust gases are commonly NO and NO₂; however, the present invention is directed to reduction of the class of nitrogen oxides identified as NO_{R}. Nitrogen oxides in exhaust are reduced with ammonia to form nitrogen and water. As previously mentioned, the reduction can be catalyzed to preferentially promote the reduction of the NOₓ over the oxidation of ammonia by the oxygen, hence “selective catalytic reduction.”

In one embodiment, the inventive method for SCR of exhaust gases may comprise (1) adding ammonia or urea to the exhaust gas to form a gas mixture; and (2) contacting the gas mixture with a catalyst comprising Fe-SAPO-34; such that the NOₓ and ammonia of the gas mixture is converted to nitrogen and water. In one embodiment, the NOₓ of the exhaust gas are substantially converted.

The Fe-SAPO-34 of the present invention may also be useful in the conversion of oxygenate-containing feedstock into one or more olefins in a reactor system. In particular, the compositions may be used to convert methanol to olefins.

There is also disclosed a method of making Fe-SAPO-34 according to the present invention. In one embodiment, this includes mixing together an organic structural directing agent, such as a tetraethylammonium hydroxide solution (e.g., 35% TEAOH), a precursor of aluminum (e.g., pseudoboehmite alumina), and de-ionized water. To such a mixture, other known ingredients, including a source of iron, phosphate and silica sol can be added while stirring, to form a gel. Crystallization seeds, such as a particular zeolite, may be added to the gel to form a desired molar composition.

The gel can then be heated in an autoclave for a time and temperature to provide a substantially pure phase composition after cooling, washing, and filtering the product. As one skilled in the art would appreciate, the product can achieve a desired SAR and/or remove organic residue upon calcination.

The present invention is also directed to a catalyst composition comprising the Fe-SAPO-34 described herein.

In one embodiment, the present invention is directed to a catalyst composition comprising Fe-SAPO-34 having an initial surface area of at least 600 m²/g, wherein the surface area, after being treated at temperatures of up to 900° C. in the presence of up to 10 vol % water vapor for up to 16 hours, is at least 80% of the initial surface area and a matrix material. In another aspect of the invention, the catalyst composition may comprise a cation-exchanged SAPO-34 composition, particularly with iron or copper.

Any suitable physical form of the catalyst may be utilized, including, but not limited to: a channeled or honeycombed-type body; a packed bed of balls, pebbles, pellets, tablets, extrudates or other particles; microspheres; and structural pieces, such as plates or tubes.

The invention will be further clarified by the following non-limiting examples, which are intended to be purely exemplary of the invention.

### EXAMPLES

### Example 1

### Direct Synthesis Fe-SAPO 34; 2460-158

Phosphoric acid, deionized water, ammonia-stabilized silica sol (Nyacol 2040NH4), TEAOH solution, ferric nitrate and pseudoboehmite alumina were mixed together to form a gel with the following composition:

0.40SiO₂:1.0Al₂O₃:1.0P₂O₅:0.025Fe₂O₃:0.75TEAOH:30.8;H₂O.

The gel was stirred at room temperature for about 30 min before charged to an autoclave. The autoclave was heated to 180° C. and maintained at the temperature for 12 hours while stirring at 300 rpm. After cooling, the product was recovered by filtration and washed with deionized water. The product was then dried and calcined to remove any organic. The resulting product had the XRD pattern of pure-phase SAPO-34, had a SiO₂/Al₂O₃ ratio (SAR) of 0.38 and contained 1.6 wt % Fe₂O₃. After calcination at 550° C. to remove organic template, the material has surface area of 709 m²/g and micropore volume of 0.27 cc/g. The calcined samples was steam-treated with 10 vol % at 700° C. for 16 hours. The steam-treated sample had surface area of 699 m²/g and micropore volume of 0.27 cc/g.

### Example 2

### Direct Synthesis Fe-SAPO 34; 2460-150

Phosphoric acid, deionized water, ammonia-stabilized silica sol (Nyacol 2040NH4), di-n-propylamine (DPA), TEAOH solution, ferric nitrate and pseudoboehmite alumina were mixed together to form a gel with the following composition:

0.40SiO₂:1.0 Al₂O₃:1.0P₂O₅:0.025Fe₂O₃:0.5 DPA:0.5 TEAOH:30.8;H₂O

The gel was stirred at room temperature for about 30 min before charged to an autoclave. The autoclave was heated to 180° C. and maintained at the temperature for 12 hours while stirring at 300 rpm. After cooling, the product was recovered by filtration and washed with deionized water. The product was then dried and calcined to remove any organic. The resulting product had the XRD pattern of pure-phase SAPO-34, had a SiO₂/Al₂O₃ ratio (SAR) of 0.32 and contained 1.6 wt % Fe₂O₃. After calcination at 550° C. to remove organic template, the material has surface area of 738 m²/g and micropore volume of 0.28 cc/g. The calcined samples was steam-treated with 10 vol % at 900° C. for 1 hour. The steam-treated sample had surface area of 543 m²/g and micropore volume of 0.25 cc/g.

### Example 3

### Direct Synthesis Fe-SAPO 34; 2550-41-1

Phosphoric acid, deionized water, silica sol (Nyacol 2040NH4), TEAOH solution, morpholine, ferric nitrate and pseudoboehmite alumina were mixed together to form a gel with the following composition:

0.40SiO₂:1.0Al₂O₃:1.1P₂O₅:0.035Fe₂O₃:0.50 TEAOH:1.0morpholine:32H₂O

The gel was stirred at room temperature for about 90 min before charged to an autoclave. The autoclave was heated to 180° C. and maintained at the temperature for 24 hours while stirring at 150 rpm. After cooling, the product was recovered by filtration and washed with deionized water. The product was then dried and calcined to remove any organic. The resulting product had the XRD pattern of SAPO-34, had a SiO₂/Al₂O₃ ratio (SAR) of 0.35 and contained 1.8 wt % Fe₂O₃.

### Example 4

### Direct Synthesis Fe-SAPO 34; 2550-5-1

Phosphoric acid, deionized water, silica sol (Nyacol 2040NH4), TEAOH solution, morpholine, ferric nitrate and pseudoboehmite alumina were mixed together to form a gel with the following composition:

0.40SiO₂:1.0Al₂O₃:1.1P₂O₅:0.050Fe₂O₃:0.50TEAOH:1.0morpholine:32H₂O

The gel was stirred at room temperature for about 90 min before charged to an autoclave. The autoclave was heated to 180° C. and maintained at the temperature for 12 hours while stirring at 150 rpm. After cooling, the product was recovered by filtration and washed with deionized water. The product was then dried and calcined to remove any organic. The resulting product had the XRD pattern of SAPO-34, had a SiO₂/Al₂O₃ ratio (SAR) of 0.36 and contained 3.1 wt % Fe₂O₃.

### Example 5

### Direct Synthesis Fe-SAPO 34; 2563-40-1

Phosphoric acid, deionized water, silica sol (Nyacol 2040NH4), TEAOH solution, morpholine, ferric nitrate and pseudoboehmite alumina were mixed together to form a gel with the following composition:

0.60SiO₂:1.0 Al₂O₃:0.95P₂O₅:0.060 Fe₂O₃:0.40 TEAOH:1.0 morpholine:33H₂O

SAPO-34 seeds (Zeolyst International) were added to the gel in an amount corresponding to 0.5 wt % of the sum of SiO₂, Al₂O₃ and P₂O₅ in the gel. The gel was stirred at room temperature for about 30 min before charged to an autoclave. The autoclave was heated to 180° C. and maintained at the temperature for 18 hours while stirring at 300 rpm. After cooling, the product was recovered by filtration and washed with deionized water. The product was then dried and calcined to remove any organic. The resulting product had the XRD pattern of SAPO-34, had a SiO₂/Al₂O₃ ratio (SAR) of 0.56 and contained 3.7 wt % Fe₂O₃. The material after calcination has surface area of 559 m²/g and micropore volume of 0.21 cc/g. The calcined sample was steam-treated with 10 vol % at 700° C. for 16 hours. The steam-treated sample had surface area of 572 m²/g and micropore volume of 0.22 cc/g.

### Example 6

### Direct Synthesis Fe-SAPO 34; 2563-57-1

Phosphoric acid, deionized water, silica sol (Nyacol 2040NH4), TEAOH solution, morpholine, ferric nitrate and pseudoboehmite alumina were mixed together to form a gel with the following composition:

0.60SiO₂:1.0 Al₂O₃:0.95P₂O₅:0.060 Fe₂O₃:0.40 TEAOH:1.0 morpholine:33H₂O

SAPO-34 seeds were added to the gel in an amount corresponding to 0.5 wt % of the sum of SiO₂, Al₂O₃ and P₂O₅ in the gel. The gel was stirred at room temperature for about 30 min before charged to an autoclave. The autoclave was heated to 180° C. and maintained at the temperature for 36 hours while stirring at 300 rpm. After cooling, the product was recovered by filtration and washed with deionized water. The product was then dried and calcined to remove any organic. The resulting product had the XRD pattern of SAPO-34, had a SiO₂/Al₂O₃ ratio (SAR) of 0.55 and contained 3.8 wt % Fe₂O₃. The material after calcination has surface area of 679 m²/g and micropore volume of 0.26 cc/g. The calcined sample was steam-treated with 10 vol % at 700° C. for 16 hours. The steam-treated sample had surface area of 673 m²/g and micropore volume of 0.26 cc/g.

### Example 7

### Direct Synthesis Fe-SAPO 34; 2565-53-1

Phosphoric acid, deionized water, silica sol (Nyacol 2040NH4), TEAOH solution, morpholine, ferric nitrate and pseudoboehmite alumina were mixed together to form a gel with the following composition:

0.40SiO₂:1.0 Al₂O₃:1.1P₂O₅:0.050 Fe₂O₃:0.50 TEAOH:1.0 morpholine:32H₂O

SAPO-34 seeds were added to the gel in an amount corresponding to 1.0 wt % of the sum of SiO₂, Al₂O₃ and P₂O₅ in the gel. The gel was stirred at room temperature for about 120 min before charged to an autoclave. The autoclave was heated to 180° C. and maintained at the temperature for 24 hours while stirring at 150 rpm. After cooling, the product was recovered by filtration and washed with deionized water. The product was then dried and calcined to remove any organic. The resulting product had the XRD pattern of SAPO-34, had a SiO₂/Al₂O₃ ratio (SAR) of 0.41 and contained 3.1 wt % Fe₂O₃. The material after calcination has surface area of 669 m²/g and micropore volume of 0.26 cc/g.

A portion of the calcined material from Example 7 was treated in dilute nitric acid. An amount of 1.60 g concentrated nitric acid was added to 129.5 g deionized water to make the dilute nitric acid. 20 g on a dry basis of the calcined material from Example 7 was added to the dilute nitric acid, and the slurry was heated to 80 C and held at this temperature for 2 hours. After cooling, the product was recovered by filtration and washed with deionized water. The sample after acid-treatment had surface area of 659 m²/g and micropore volume of 0.25 cc/g. The acid-treated material was then steam-treated with 10 vol % at 700° C. for 16 hours and 900° C. for 1 hour, respectively. The 700° C./16 h steam-treated sample had surface area of 681 m²/g and micropore volume of 0.27 cc/g. The 900° C./1 h steam-treated sample had surface area of 670 m²/g and micropore volume of 0.26 cc/g.

### Steam Treatment

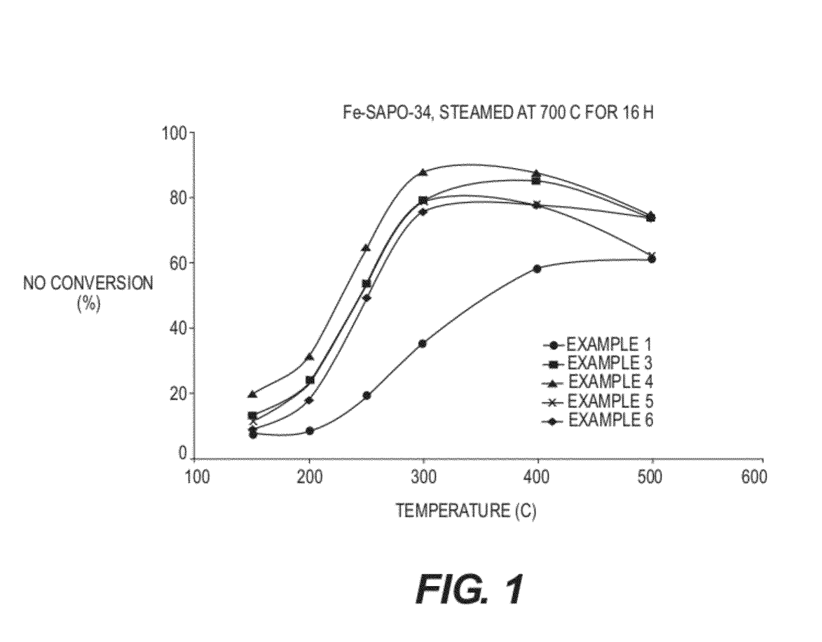

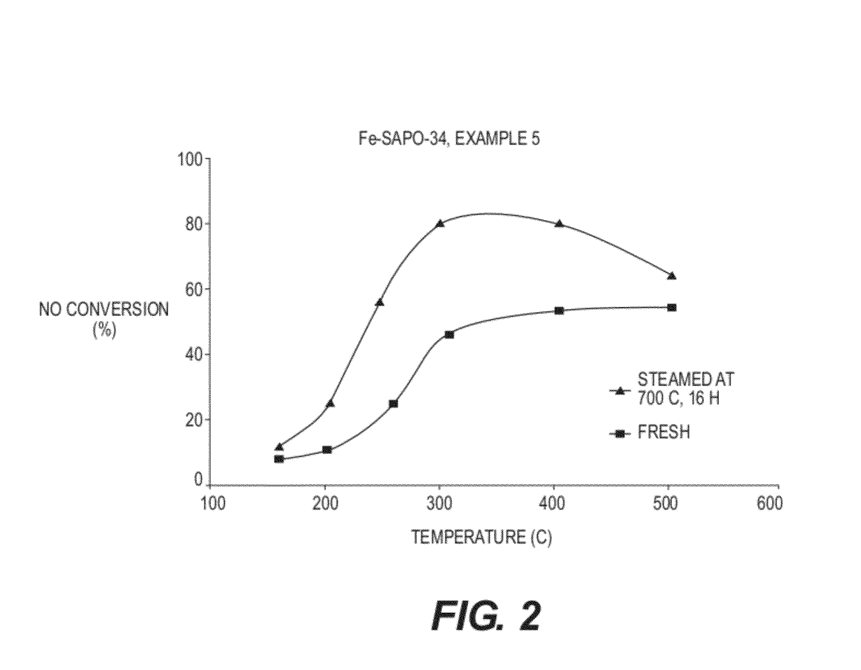

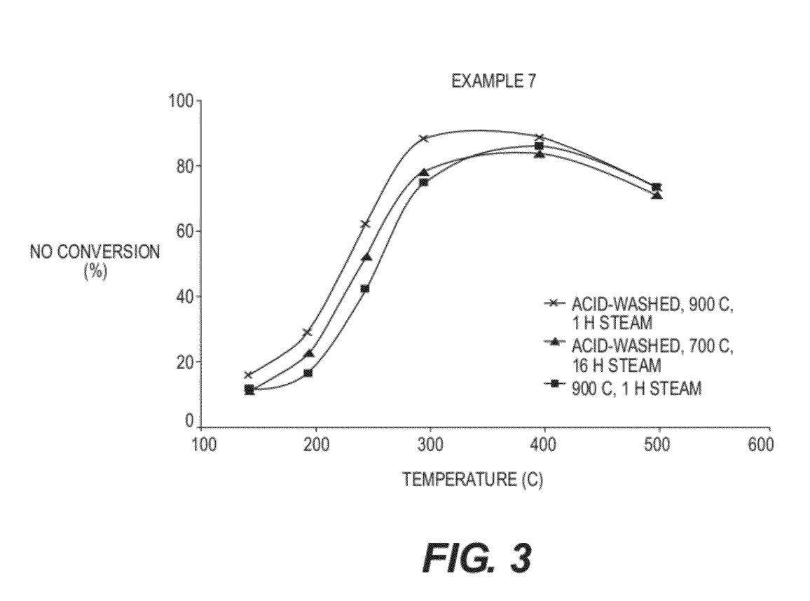

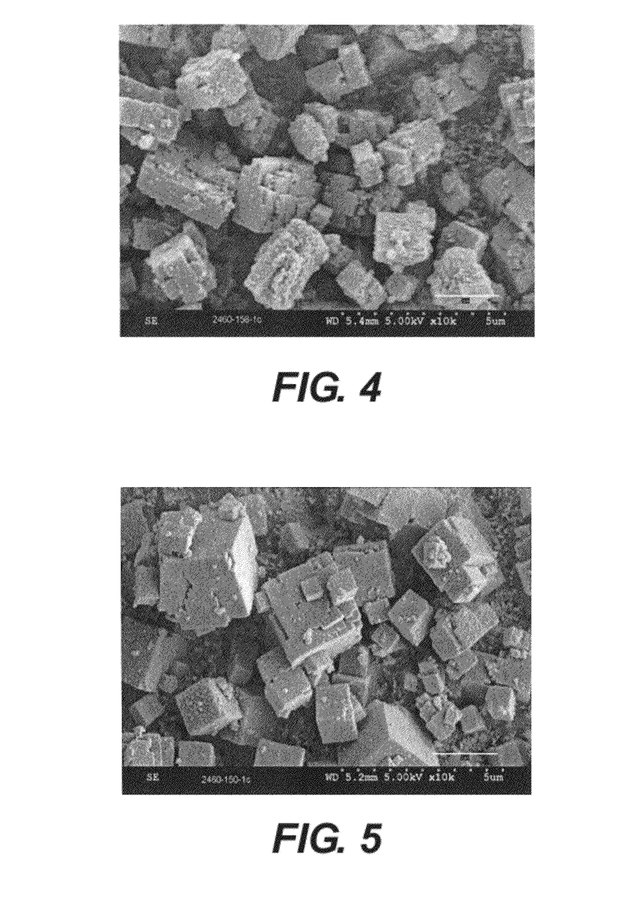

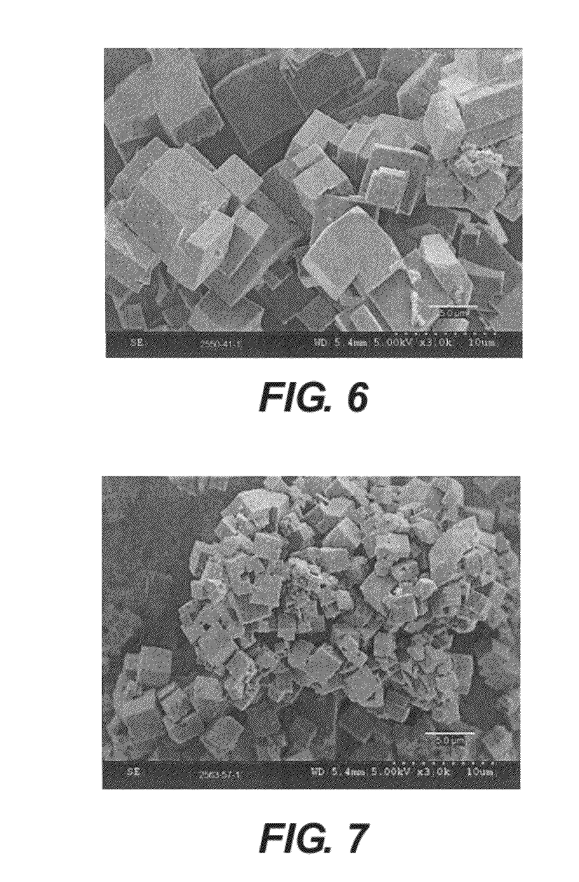

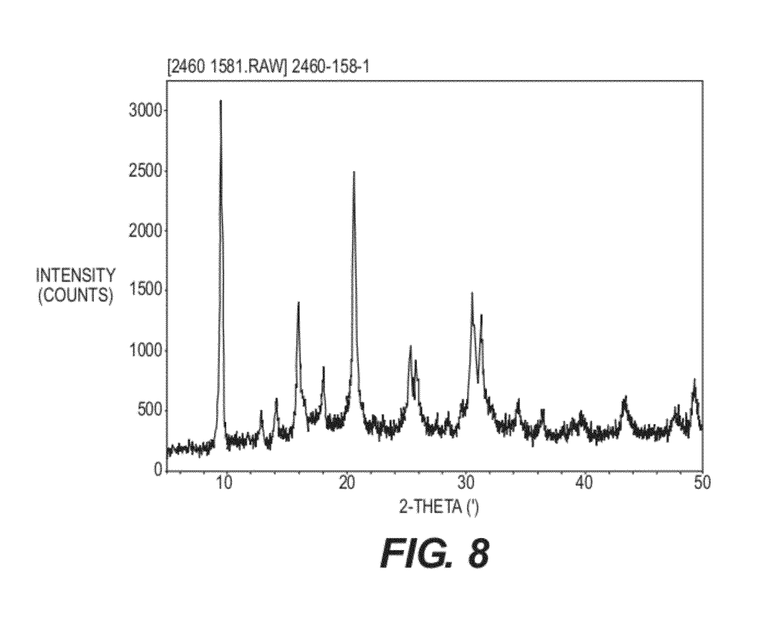

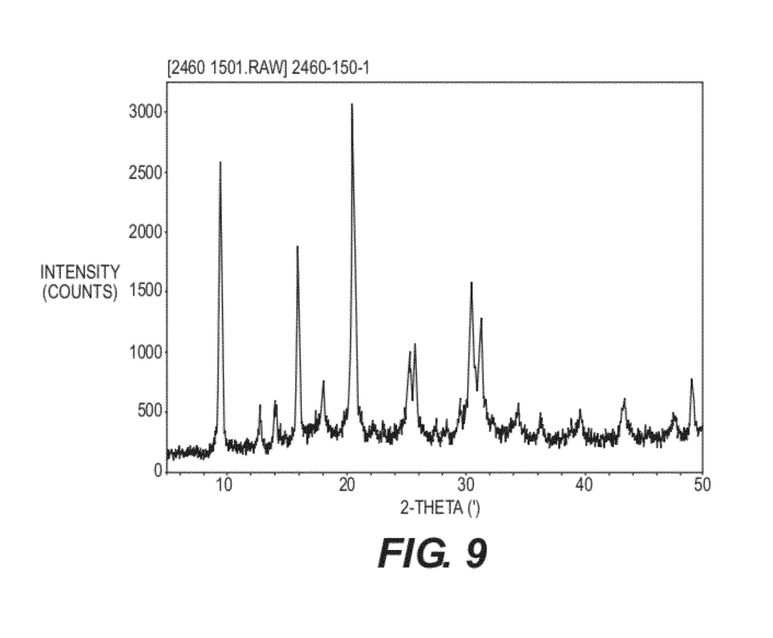

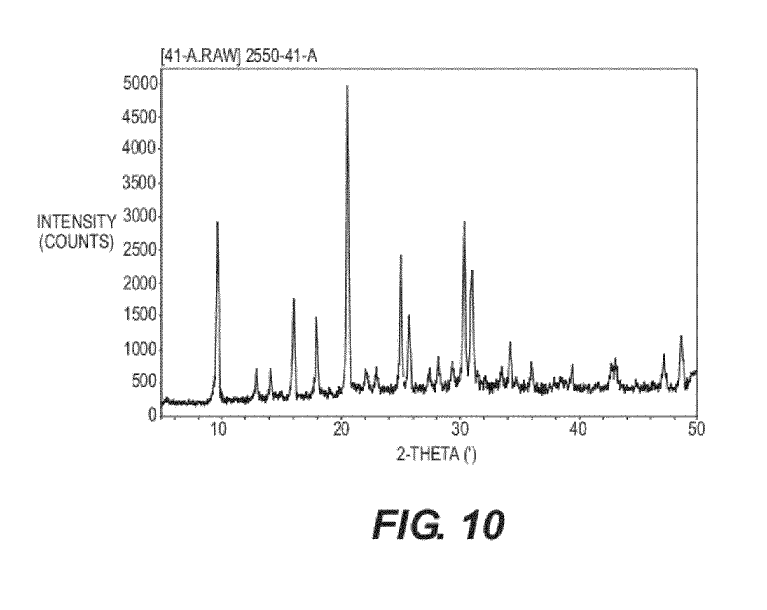

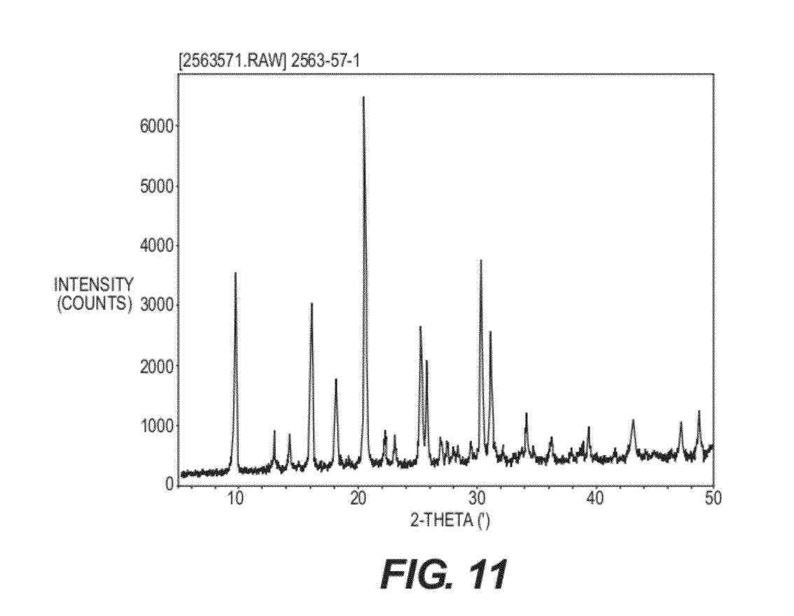

The foregoing samples were treated with steam at temperatures ranging from 700-900° C. in the presence of 10 percent volume water vapor for 1 to 16 hours. The activities of the steamed materials for NOx conversion, using ammonia as reductant, were tested with a flow-through type reactor. Powder zeolite samples were pressed and sieved to 35/70 mesh and loaded into a quartz tube reactor. Reactor temperature was ramped and NOx conversion was determined with an infrared analyzer at each temperature interval. The results and the gas stream conditions appear below in FIGS. 1-3.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with the true scope of the invention being indicated by the following claims.

What we claim is:

1. A catalyst comprising an Fe-SAPO-34 molecular sieve, wherein said molecular sieve contains both framework iron and iron cations at ion-exchange sites.

2. The catalyst of claim 1, wherein said Fe-SAPO-34 contains at least 0.5-10 weight percent of iron (Fe) of the total weight of said catalyst.

3. The catalyst of claim 1, wherein said Fe-SAPO-34 contains at least 1-20 weight percent of SiO₂ of the total weight of said molecular sieve.

4. The catalyst of claim 1, said Fe-SAPO-34 having a crystal size greater than 0.3 microns.

5. The catalyst of claim 4, wherein said Fe-SAPO-34 has a crystal size up to 10 micron.

6. The catalyst of claim 1, wherein said Fe-SAPO-34 exhibits a selective catalytic reduction of Nitrogen Oxides (NOx) with ammonia or urea of greater than 40% conversion at 250-300° C. in exhaust gases.

7. A catalyst comprising an Fe-SAPO-34 molecular sieve, wherein said molecular sieve contains Fe in an amount sufficient to achieve a selective catalytic reduction of Nitrogen Oxides (NOx) with ammonia or urea of greater than 40% conversion at 250-300° C.

8. The catalyst of claim 7, wherein said molecular sieve maintains at least 80% of its initial surface after being treated at temperatures up to 700° C. in the presence of up to 10 vol % water vapor for 16 hours.

9. A method of selective catalytic reduction (SCR) of NOx in exhaust gas, said method comprising: contacting exhaust gas with a catalyst comprising an Fe-SAPO-34, wherein said molecular sieve contains both framework iron and iron cations at ion-exchange sites.

10. The method of claim 9, wherein said contacting step is performed in the presence of ammonia, urea or an ammonia generating compound.

11. The method of claim 9, wherein said Fe-SAPO-34 contains 0.5-10 weight percent of iron (Fe) of the total weight of said molecular sieve.

12. The method of claim 11, wherein said Fe-SAPO-34 contains 1.0-5.0 weight percent of iron (Fe) of the total weight of said molecular sieve.

13. The method of claim 9, wherein said Fe-SAPO-34 contains at least 1-20 weight percent of SiO₂ of the total weight of said molecular sieve.

14. The method of claim 9, wherein said Fe-SAPO-34 exhibits a selective catalytic reduction of nitrogen oxides with ammonia or urea of greater than 40% conversion at 250-300° C. in exhaust gases.

15. A method of making a catalyst comprising Fe-SAPO-34, said method comprising mixing sources of an iron salt, alumina, silica, phosphate, at least one organic structural directing agent and water to form a gel; heating said gel in an autoclave at a temperature ranging from 140 to 220° C. to form a crystalline Fe-SAPO-34 product; calcining said product; and contacting said product with acid or steam.

16. The method of claim 15, wherein said iron salt is ferrous or ferric salt chosen from nitrate, chloride, or sulfate.

17. The method of claim 15, wherein said alumina is pseudoboehmite alumina.

18. The method of claim 15, wherein said source of silica is chosen from silica sol, precipitated silica, or silica gel.

19. The method of claim 15, wherein said source of phosphate is phosphoric acid.

20. The method of claim 15, wherein said organic structural directing agent is chosen from tetraethylammonium hydroxide (TEAOH), dipropylamine, morpholine, triethylamine, or a mixture thereof.

21. The method of claim 15, wherein said acid treatment is contacting Fe-SAPO-34 catalyst with an acid solution chosen from mineral acid or organic acid.

22. The method of claim 15, wherein said contacting said product with steam comprises contacting said product with a gas stream containing water vapor in a temperature range of 200-900° C.
